(19) United States
(12) Patent Application Publication
(10) Pub. No.: US 2008/0035859 A1
(43) Pub. Date: Feb. 14, 2008

(54) Photo-stimulable phosphor imaging plate

(75) Inventors: Roberto Molteni, Arlington Heights, IL (US); Jurgen Kreutz, Ingolstadt (DE)

Correspondence Address: COOPER & DUNHAM, LLP, 1185 AVENUE OF THE AMERICAS, NEW YORK, NY, 10036, US

(73) Assignee: AFP Imaging Corporation

(21) Appl. No.: 11/501,304

(22) Filed: Aug. 9, 2006

(51) Int. Cl. H05B 33/00

(52) U.S. Cl. 250/484.4

(57) ABSTRACT

A photo-stimulable phosphor imaging plate includes a substrate layer for providing structural support. A photo-stimulable layer is provided over the substrate layer. The photo-stimulable layer is effective to carry a latent x-ray image. A thick protective layer of a thickness and rigidity effective to protect the photo-stimulable layer from physical damage when being handled is provided over the photo-stimulable layer. The thick protective layer may further be variously transparent, reflecting, or absorbent, at different wavelengths, so to provide a degree of protection against fading of the latent image caused by inadvertent exposure to ambient light.

### BACKGROUND

1. Technical Field

The present disclosure relates to radiographic imaging and, more specifically, to a photo stimulable phosphor imaging plate.

2. Description of the Related Art

Radiography may be used to image all forms of objects. For example, radiography may be used by security personnel to image personal property.

Medical radiography is the process of using x-rays to visualize the internal structure of a patient or subject. This process generally involves positioning the subject between an x-ray source and an x-ray detector. X-rays of various wavelengths may be used to penetrate matter of various densities and thus provide images of structures for which visible light cannot pass through, such as bones and internal organs.

Medical radiography may be used by radiologists, dentists, veterinarians and medical technicians to image various portions of human and animal subjects. Dental radiography may be particularly challenging owing to the fine level of detail that is generally required and the desire to limit a subject's exposure to potentially hazardous x-ray radiation.

Traditional x-ray detectors comprised x-ray sensitive film that could be exposed by x-rays that have passed through the subject. Subsequent developing of the x-ray film would provide lasting images of a subject's internal structure.

More recent methods of medical radiography use digital x-ray imagers in place of x-ray sensitive film. There are two primary types of digital x-ray imagers, direct radiography (DR) and computed radiography (CR).

Direct radiography uses a detector panel comprising a matrix of x-ray sensors that generate electrical signals based on x-ray exposure. While direct radiography detector panels are well suited for many types of medical radiography, it may be difficult to implement certain types of medical radiography using direct radiography. For example, in dental radiography, placing a direct radiography detector panel inside a subject's mouth may not be the most convenient method for all kinds of diagnostic procedures.

In computed radiography, an imaging plate coated with a photo stimulated phosphor (PSP) is used in place of x-ray sensitive film. X-ray exposure to the imaging plate creates a latent image as the exposed molecules of the PSP are energized. The imaging plate may then be exposed to visible light, for example, by being scanned with a laser. Upon being exposed to light, the energized PSP molecules fall back to their original energy state, emitting visible light in the process. The intensity of the emitted visible light is directly proportional to the degree of x-ray exposure. Accordingly, the pattern of emitted visible light corresponding to x-ray exposure and thus the internal structure of the subject, can be detected and converted into an electrical signal by a suitable high-sensitivity photo-detector, such a photo-multiplier tube.

The PSP may subsequently be reset, for example, by exposure to light in order to remove all remaining latent signal that the read-out exposure may not have fully removed, and is thereafter ready for reuse.

Conventional PSPs may be highly susceptible to physical damage. Even slight scratches and cracks may result in obstructive artifacts in the resultant radiographic image. Therefore, PSP imaging plates are generally housed in large cassettes similar to cassettes used to house x-ray sensitive film. To ensure proper handling of fragile PSP imaging plates, loading and unloading of the imaging plates from the cassettes may be automated. Automation also has the added advantage of avoiding exposing the imaging plate to ambient light that may degrade the latent image.

However, the use of cassettes and automated handling generally requires large and expensive machinery that may not be well suited for such fields as dental and veterinary radiography. In such fields, for example, in intraoral dental radiography, cassettes may not easily fit into the mouths of subjects. Moreover, automatic handling equipment may not be cost effective.

Intraoral applications of computed radiography therefore generally involve the use of an imaging plate that comprises a thin PSP layer mounted on a thin substrate. A very thin protective layer, on the order of a few microns, made of, for example, aliphatic urethancynacrilate, may coat the PSP layer to provide some level of protection against chemically-adverse substances and to protect against hydroscopic absorption of water molecules which may be detrimental to the PSP layer. The imaging plate may then be manually placed into a protective pouch and inserted into the subject's mouth. The imaging plate must then be manually removed from the protective pouch and inserted into a scanner where the latent image may be digitally read.

One significant drawback with conventional intraoral CR imaging plates is that their useful life is significantly reduced by physical damage that results from manual handling. Additionally, prolonged exposure to ambient light due to mishandling may result in a degraded image with poor signal-to-noise characteristics. Accordingly, an improved CR imaging plate is desired that has improved resistance to physical damage and/or improved resistance to ambient light while maintaining a small form and avoiding the need for automated handling equipment.

### SUMMARY

A photo-stimulable phosphor imaging plate includes a substrate layer for providing structural support. A photo-stimulable layer is provided over the substrate layer. The photo-stimulable layer is effective to carry a latent x-ray image. A thick protective layer of a thickness and rigidity effective to protect the photo-stimulable layer from physical damage when being handled is provided over the photo-stimulable layer.

A method for manufacturing a computed radiography imaging plate includes providing a photo-stimulable layer over a substrate layer. The photo-stimulable layer is effective to carry a latent x-ray image. A thick protective layer of a thickness and rigidity effective to protect the photo-stimulable layer from physical damage when being handled is provided over the photo-stimulable layer.

The thick protective layer may further be variously transparent, reflecting, or absorbent, at different wavelengths, so to provide a degree of protection against fading of the latent image caused by inadvertent exposure to ambient light.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a planar view of an imaging plate according to an embodiment of the present invention; and

FIG. 2 is a cross section view of an imaging plate according to an embodiment of the present invention.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present invention include an improved CR imaging plate that has improved resistance to physical damage and/or improved resistance to ambient light while maintaining a small form and avoiding the need for automated handling equipment. Such imaging plates therefore may be ideally suited for intraoral and veterinary computed radiography. However, embodiments of the present invention should be understood to have broad uses that extend to other fields of medical radiography and radiography in general.

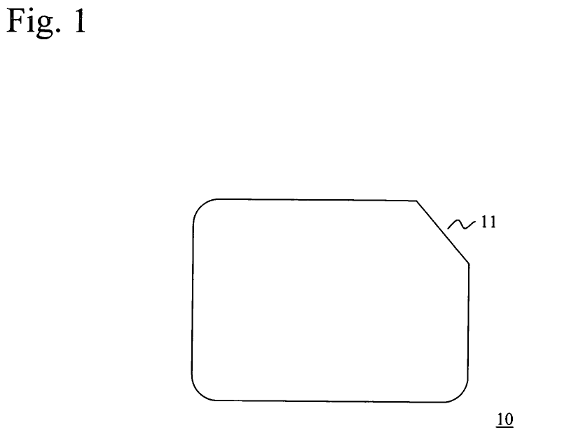

FIG. 1 shows an example of an imaging plate according to an embodiment of the present invention. The imaging plate 10 may be of a size suitable for human intraoral placement. For example, the imaging plate 10 may conform to standard intraoral sizes, for example, size 0 (22×35 mm), size 1 (24×40 mm), size 2 (31×41 mm), size 3 (27×54 mm), and/or size 4 (57×76 mm). One of the four corners 11 of the imaging plate 10 may be distinctly shaped so that the orientation of the resultant radiographic image may be easily determined. This distinction may help the operator (for example, dentist, radiologist, or dental assistant) distinguish between images taken of the upper dental arch (the maxilla) and the lower dental arch (the mandible), and between images of the right side and of the left side of the dentition.

For example, one of the four corners 11 may be shaped with a blended chamfer, while the others of the four corners would retain the standard rounding with a 7 mm radius. The blended chamfer of the one corner 11 may allow for the imaging plate to still fit inside a conventional pouch with four rounded corners. Alternatively, another shape may be selected. Where the shape selected prevents fit into a conventional pouch, a non-standard pouch may be used.

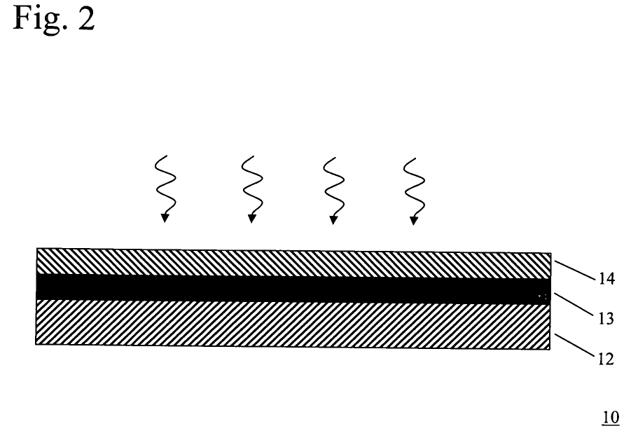

Embodiments of the present invention may include a layer for added physical protection. FIG. 2 shows an example of an imaging plate according to an embodiment of the present invention. The imaging plate 10 may have a substrate layer 12. The substrate layer 12 may be comprised of, for example, a black opaque high-density polyester with a thickness of approximately 0.2 mm. A photo stimulated phosphor (PSP) layer 13 may be formed on top of the substrate layer 12. A PSP thickness is preferably within the range of 0.02 mm to 0.20 mm. It is believed that a PSP layer within this range would provide a good balance between sensitivity and image sharpness. For example, the PSP layer 13 may be approximately 0.05 mm thick. The PSP layer 13 may be capable of capturing a latent image from x-ray exposure. The PSP layer is so named for its ability to exhibit the phenomenon of phosphorescence and generally does not contain the element phosphorus. Many suitable phosphor materials are known in the art, for instance barium fluoro halide with traces of rare-earth dopant(s).

A thick protective layer 14 may be placed on the PSP layer 13. The thick protective layer 14 may be sufficiently thick and hard to resist physical and mechanical stimulus that may occur during use and handling. The thick protective coating may additionally be chemically inert and impervious to water and/or other substances. For example, the thick protective layer 14 may comprise polyethylene terephthalate polyester (PETP) or another suitable material. The thick protective layer 14 may be, for example, approximately 0.05 mm thick. The thick protective layer may be applied, for example, via heat lamination during the production of the imaging plate stock.

According to some embodiments of the present invention, the thick protective layer 14 may replace the very thin layer of aliphatic urethancynacrilate that is used to protect the PSP layer from chemically-adverse substances and hydroscopic absorption as used in the art. Alternatively, the thick protective layer 14 may be placed on top of the very thin layer of aliphatic urethancynacrilate.

The thick protective layer is thick in comparison to the very thin layer of aliphatic urethancynacrilate which is generally on the order of several microns thick. Accordingly, the thick protective layer may be approximately an order of magnitude thicker than the very thin layer.

According to some embodiments of the present invention, the thick protective layer may be highly transparent. The thick protective layer may be especially transparent at the wavelength used to stimulate the photo-stimulable layer during the scanning procedure employed after x-ray exposure has occurred. For example, where a red laser is used for stimulation, the thick protective layer may be highly transparent of red light.

The thick protective layer may also be especially transparent at the wavelengths emitted by the photo-stimulable layer after stimulation at least to the extent that such light is detectable by the photo-detectors being used. For example, because the photo-detectors used to detect the emitted light generally register light in the green-blue wavelengths, the thick protective layer may be especially transparent at green-blue wavelengths.

The thick protective layer may optionally be highly transparent at other wavelengths of light; however, according to other embodiments of the present invention, the thick protective layer may be designed to be opaque at wavelengths of light that are not used for stimulation or emission detection. This may allow for at least partial blockage of ambient light that may be responsible for image degradation or fading during periods of time that the imaging plate is exposed to ambient light. In this way, the thick protective layer serves to reduce image fading.

For example, the thick protective layer may act as an optical filter that preferentially transmits only the narrow-band wavelength required to stimulate the PSP layer (for example red) and the broad-band wavelengths which are emitted by the PSP layer and detected by the photo-detectors (for example green-blue).

Accordingly, the thick protective layer could present a degree of opacity to all other light wavelengths that are not the stimulation wavelength or the emitted wavelengths.

To achieve the desired color blocking properties, the thick protective layer may be fashioned as an optical color-band-stop filter. Alternatively, the protective coating could be optically-tailored so to preferentially transmit only the useful wavelengths precisely, for instance as a multi-band-pass interferometric filter.

In order to provide the desired optical absorption properties, the thick protective layer must be sufficiently thick. Therefore, the thick protective layer may be thick enough to offer suitable physical protection and at the same time to provide suitable optical protection. To achieve these goals, the thick protective layer may comprise multiple sub-layers, and each sub-layer may specifically provide opaqueness for particular wavelengths.

Embodiments of the present invention have been successfully tested, with several sets of different tests:

One set of tests was done to verify that the presence of thick protective layer would not detrimentally affect image quality, by comparing resolution and x-ray sensitivity achieved with imaging plates with and without thick coating layer.

Another set of test was conducted to verify the extent of protection to mechanical abuses that the extra thick coating layer can provide respect to unprotected imaging plates.

A further set of tests was conducted to reconfirm that image resolution and x-ray sensitivity achievable with the prototype PSP imaging plates coated with the extra protective layer is comparable to that of existing commercial PSP imaging plates.

In the first set of such tests, four intraoral imaging plates each with a PSP layer of thickness 0.180 mm were tested. In a first test imaging plate, the PSP layer was coated with only the standard very thin layer of aliphatic urethancynacrilate. A second test imaging plate added a thick protective layer of thickness 0.05 mm on top of the thin aliphatic urethancynacrilate layer. A third test imaging plate added a thick protective layer of thickness 0.20 mm on top of the thin aliphatic urethancynacrilate layer. A fourth test imaging plate lacked the thin aliphatic urethancynacrilate layer and had only a thick protective layer of thickness 0.05 mm. A commercial, conventional Fujifilm BAS PSP imaging plate was also tested for comparison. The PSP layer thickness of the Fujifilm BAS is believed to be approximately 0.090 mm thick.

The test imaging plates and the conventional plate were exposed using a 65 kV, 7 mA, DC x-ray source at Source-Detector Distance=33 cm. The first test imaging plate exhibited a sensitivity that was approximately 2.6 times greater than the Fujifilm BAS imaging plate. The second and third test imaging plate exhibited a sensitivity that was approximately 2.1 times greater than the Fujifilm BAS imaging plate. The fourth imaging plate exhibited a sensitivity that was approximately 2.3 times the Fujifilm BAS imaging plate.

It should be noted that an enhanced sensitivity coincides with a reduced dynamic range of approximately the same factor.

Accordingly, it was determined that the presence of the thick protective layer did not significantly reduce imaging plate sensitivity.

In another test, the maximum visually-detectable spatial resolution in line pairs per millimeter (lp/mm) was evaluated with a converging-line-pair test object, limit resolution 10 lp/mm, positioned at 30° from the scanning axis. Exposures were made at 40 ms and 80 ms. The test imaging plates were compared against data obtained from a conventional Fujifilm BAS imaging plate. Scanning was performed at different scanning resolutions, as possible with the Gendex DenOptix PSP scanner, that is 600 DPI and 300 DPI (DPI=Dot-per-Inch). The results were as follows:
Fujifilm BAS scanned at 600 DPI: 8 lp/mm
Test Plate 1 scanned at 600 DPI: 7 lp/mm
Test Plate 2 scanned at 600 DPI: 7 lp/mm
Test Plate 4 scanned at 600 DPI: 7 lp/mm
Fujifilm BAS scanned at 300 DPI: 5.5 lp/mm
Test Plate 1 scanned at 300 DPI: 5 lp/mm
Test Plate 2 scanned at 300 DPI: 5 lp/mm
Test Plate 4 scanned at 300 DPI: 5 lp/mm

Accordingly, the maximum visually-detectable spatial resolution was comparable for each test imaging plate, whether coated or uncoated, suggesting that the thick protective layer did not substantially adversely effect maximum visually-detectable spatial resolution.

At 600 DPI, the Fujifilm BAS conveys a perception of better crispness than each of the test plates. This phenomenon was not observed at 300 DPI. This perception of better crispness is believed to be the result of the thinner PSP layer used by the Fujifilm BAS. Accordingly, it was concluded that reducing the PSP layer in the test plates, for instance to 0.090 mm or less, would allow embodiments of the present invention to achieve crispness comparable to or better than the Fujifilm BAS imaging plate.

In mechanical abuse testing, the second, third and fourth test imaging panels were tested for scratch resistance against a Fujifilm BAS imaging plate. The test procedure included dragging a 1 mm spherical point needle across each plate at a force ranging from 100 to 800 mN in 100 mN increments prior to x-ray exposure and image capture. The second and fourth test imaging panel required approximately 10 times more pressure to produce the same image defect as the standard imaging plate. The third test imaging panel required in excess of 26 times more pressure to produce the same image defect as the Fujifilm BAS imaging plate.

Accordingly, it was demonstrated that the test imaging plates including the thick protective layer provided substantially better physical protection than the imaging plates that lacked the thick protective coating.

In subsequent sensitivity testing, a test plate having a PSP layer thickness of 0.090 mm and a thick protective layer of thickness 0.05 mm and a test plate having a PSP layer of 0.090 mm without a thick protective layer were tested against the standard Fujifilm BAS imaging plate.

In sensitivity testing, the sensitivity response of both test plates appeared to be 2.3 times higher than that of the Fujifilm BAS imaging plate with the sensitivity of the test plate without the thick protective layer being approximately 10% higher than the test plate with the thick protective coating. Therefore, the reduction of sensitivity caused by the thick protective layer appeared to be within acceptable margins.

In further testing of spatial resolution, the maximum visually-detectable spatial resolution in line pairs per millimeter (lp/mm) was evaluated with a converging-line-pair test object, limit resolution 10 lp/mm, positioned at 30° from the scanning axis. Exposures were made between 50 ms and 160 ms. The test imaging plates were compared against data obtained from a conventional Fujifilm BAS imaging plate. The results were as follows:
Fujifilm BAS, scanned at 600 DPI: 8 lp/mm
Test plate with thick coating, scanned at 600 DPI: 7 lp/mm
Test plate without thick coating, scanned at 600 DPI: 7 lp/mm
Fujifilm BAS, scanned at 300 DPI: 6 lp/mm
Test plate with thick coating, scanned at 300 DPI: 5.5 lp/mm
Test plate without thick coating, scanned at 300 DPI: 5.5 lp/mm

Accordingly, it was demonstrated that image performances with the test imaging plate having the thick protective coating was about as good as, or better than, the conventional imaging plate, and the presence of the thick protective coating did not significantly reduce the resultant image quality.

The observance of marginally lower spatial resolution respect to the Fujifilm BAS imaging plate is believed to be inconsequential, especially at the 300 DPI scanning resolution that is most frequently used for dental imaging.

A further set of test was conducted with imaging plates having a PSP layer of approximately only 0.05 mm, and a protective layer of 0.05 mm. It was found that both resolving power (in lp/mm) and sensitivity were comparable and very close to those achieved with Fujifilm BAS imaging plates.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A photo-stimulable phosphor imaging plate comprising:
a substrate layer for providing structural support;
a photo-stimulable layer positioned over the substrate layer, the photo-stimulable layer being effective to carry a latent x-ray image; and
a thick protective layer of a thickness and rigidity effective to protect the photo-stimulable layer from physical damage when being handled, positioned over the photo-stimulable layer;
wherein the thick protective layer absorbs or reflects one or more wavelengths other than a wavelength used to scan the photostimulable phosphor imaging plate after x-ray exposure and broad-band wavelengths emitted by the photo-stimulable layer upon stimulation.

2. The photo-stimulable phosphor imaging plate of claim 1, wherein the substrate layer is comprised of an opaque high-density polyester of approximately 0.2 mm thick.

3. The photo-stimulable phosphor imaging plate of claim 1, wherein the photo-stimulable layer is approximately 0.05 mm thick.

4. The photo-stimulable phosphor imaging plate of claim 1, wherein the thick protective layer is comprised of polyethylene terephthalate polyester (PETP).

5. The photo-stimulable phosphor imaging plate of claim 1, wherein the thick protective layer is within the range of approximately 0.02 mm to 0.10 mm thick.

6. The photo-stimulable phosphor imaging plate of claim 1, wherein the thick protective layer is approximately 0.05 mm thick.

7. The photo-stimulable phosphor imaging plate of claim 1, wherein a thin protective layer made of aliphatic urethane acrylate coats the photo-stimulable layer and separates the photo-stimulable layer from the thick protective layer.

8. The photo-stimulable phosphor imaging plate of claim 1, wherein the thick protective layer is transparent at a wavelength required to stimulate the photo-stimulable layer and at the broad-band wavelengths emitted by the photo-stimulable layer upon stimulation.

9. (canceled)

10. The photo-stimulable phosphor imaging plate of claim 1, wherein one of the corners of the photo-stimulable phosphor imaging plate is identifiably shaped so that the orientation of resulting images may be easily identified.

11. A method for obtaining a radiographic image using the photo-stimulable phosphor imaging plate of claim 1.

12. A method for manufacturing a computed radiography imaging plate, comprising:
providing a photo-stimulable layer over a substrate layer, the photo-stimulable layer being effective to carry a latent x-ray image; and
providing a thick protective layer of a thickness and rigidity effective to protect the photo-stimulable layer from physical damage when being handled over the photo-stimulable layer; and
protecting the photo-stimulable layer from ambient light by absorbing or reflecting one or more wavelengths other than a wavelength used to scan the photo-stimulable phosphor imaging plate after x-ray exposure and broad-band wavelengths emitted by the photo-stimulable layer upon stimulation.

13. The method of claim 12, wherein the substrate layer is comprised of an opaque high-density polyester of approximately 0.2 mm thick.

14. The method of claim 12, wherein the photo-stimulable layer is approximately 0.05 mm thick.

15. The method of claim 12, wherein the thick protective layer is comprised of polyethylene terephthalate polyester (PETP).

16. The method of claim 12, wherein the thick protective layer is within the range of approximately 0.02 mm to 0.10 mm thick.

17. The method of claim 12, wherein the thick protective layer is approximately 0.05 mm thick.

18. The method of claim 12, further providing a thin protective layer made of aliphatic urethane acrylate over the photo-stimulable layer to separate the photo-stimulable layer from the thick protective layer.

19. The method of claim 12, wherein the thick protective layer is transparent at a wavelength required to stimulate the photo-stimulable layer and at broad-band wavelengths emitted by the photo-stimulable layer upon stimulation.

20. (canceled)
